(19) United States
(12) Patent Application Publication
(10) Pub. No.: US 2016/0294181 A1
(43) Pub. Date: Oct. 6, 2016

(54) OVERVOLTAGE PROTECTION FOR A MOTOR VEHICLE ELECTRICAL SYSTEM IN THE EVENT OF LOAD SHEDDING

(71) Applicant: ROBERT BOSCH GMBH, Stuttgart (DE)

(72) Inventors: Christopher OTTE, Reutlingen (DE); Paul MEHRINGER, Stuttgart (DE)

(21) Appl. No.: 15/037,279

(22) PCT Filed: Nov. 10, 2014
(86) PCT No.: PCT/EP2014/074133

§ 371 Date: May 17, 2016

(30) Foreign Application Priority Data
Nov. 26, 2013 (DE) 10 2013 224 106.2

(51) Int. Cl. H02H 7/06; H02P 9/00; H02M 7/219

(52) U.S. Cl. CPC H02H 7/067; H02M 7/219; H02P 9/006

(57) ABSTRACT

A method for operating a motor vehicle electrical system which includes an electric machine, and an active bridge rectifier connected to the electric machine via phase connections. After the bridge rectifier has been operated at least once in a short circuit operating mode, a determination is made, based on at least one feature of a signal which characterizes a voltage that drops between the direct voltage terminals of the bridge rectifier, whether the signal has exceeded the upper threshold value due to a cable break at at least one of the direct voltage terminals. If so, the bridge rectifier is subsequently operated in the short circuit operating mode for an extended period of time, and/or a control signal having a second switching time greater than that in the first method phase is used for controlling the active switching elements.

### FIELD

The present invention relates to a method for operating a motor vehicle electrical system and an implementation of the method.

### BACKGROUND INFORMATION

Rectifiers of various designs may be used for feeding direct current systems out of three-phase current systems, of motor vehicle electrical systems, for example, using three-phase current generators. Bridge rectifiers having a six-, eight-, or ten-pulse design are used in motor vehicle electrical systems, corresponding to the three-, four-, or five-phase current generators which are usually installed here. However, the present invention is also suitable for bridge rectifiers having other numbers of phases.

When reference is made below to a generator for the purpose of simplicity, this may also be an electric machine which is operable in a generator mode and a motor mode, for example a starter generator.

So-called load shedding (dumping) is a critical operating condition in bridge rectifiers. Load shedding occurs when, for a highly excited generator and a correspondingly high delivered current, the load on the generator or the bridge rectifier connected thereto suddenly decreases. Load shedding may result either from a disconnection of consumers in the connected vehicle electrical system, or from a cable break.

When consumers are suddenly disconnected during battery-free operation of the vehicle electrical system, the generator may supply, for up to one second, more energy than the vehicle electrical system is able to receive. If it is not possible to intercept or completely intercept this energy by capacitively acting elements in the direct voltage network or in the rectifier, overvoltages, and thus overvoltage damage to components in the motor vehicle electrical system, may occur. In such a case, however, the vehicle electrical system must continue to be supplied with power from the generator, since supplying power from the battery as an interim solution is out of the question. Load shedding is not critical as long as a battery is connected. The load dumping may cause damage only during battery-free operation, which represents a fault condition.

In the event of a cable break at the positive direct voltage terminal of the bridge rectifier, the generator likewise continues to supply energy, but a consumer is no longer connected. In comparison to the case just discussed for the disconnection of consumers during battery-free operation of the vehicle electrical system, the consumers are not endangered. Nonetheless, overvoltages may occur which may damage the power electronics of the generator.

In conventional (passive) bridge rectifiers, in each case a certain amount of protection of the vehicle electrical system or the power electronics of the generator is provided by the rectifier itself, namely, with the aid of the rectifier Zener diodes, installed there in the classical case, in which the overvoltage may be arrested and the excess energy may be converted into heat.

However, as described in German Patent Application No. DE 10 2009 046 955 A1, for example, the use of active or controlled bridge rectifiers is desirable in motor vehicles. This is the case, among other reasons, due to the fact that active bridge rectifiers, in contrast to passive or uncontrolled bridge rectifiers, have lower power losses during normal operation. However, presently available controllable or active switching elements for such active bridge rectifiers, for example MOSFETs, have no integrated arresting function with sufficient robustness, as is the case for conventional rectifier Zener diodes, and therefore are not able to intercept the overvoltage. For this reason, additional protective strategies are necessary in active bridge rectifiers.

During load shedding, for example the generator phases may be short-circuited by temporarily conductively connecting some or all switching elements of the upper or lower rectifier branch of a corresponding rectifier, for example as also described in German Patent Application No. DE 198 35 316 A1 and discussed in German Patent Application No. DE 10 2009 046 955 A1. This takes place in particular on the basis of an evaluation of the output voltage present at the direct voltage terminals of the active bridge rectifier. If the output voltage exceeds a predefined upper threshold value, a corresponding short circuit is initiated and the output voltage drops. If the output voltage subsequently falls below a predefined lower threshold value, the short circuit is eliminated and the output voltage rises again.

Therefore, this is typical hysteresis behavior. Thus, during load shedding the output voltage oscillates between the upper and the lower threshold value.

However, these conventional approaches have not always proven satisfactory, so that there is a need for improved protective strategies for active bridge rectifiers in the event of load shedding.

### SUMMARY

The present invention provides a method for operating a motor vehicle electrical system, and an implementation of the method. Example embodiments are described below.

A motor vehicle electrical system or an electric machine together with a bridge rectifier and a control device of such a motor vehicle electrical system, upon which the present invention may be based, is explained in greater detail below with reference to FIG. 1.

The present invention is directed to a method for operating a motor vehicle electrical system of this type which includes an electric machine which is operable in a generator mode, and an active bridge rectifier which is connected to the electric machine via phase connections and which is operable in a rectifier operating mode and in a short circuit operating mode.

Within the scope of the present patent application, a “rectifier operating mode” is understood to mean an operating mode as used for routine rectification in the absence of load shedding, and after load shedding, between the short circuit operating modes discussed below. Such a rectifier operating mode includes converting phase voltages present at the phase connections into an output voltage, which is output at direct voltage terminals of the bridge rectifier, by controlling active switching elements of the bridge rectifier. Such a rectifier operating mode is known in this regard. Typically, a positive half-wave present at the particular phase connections is hereby switched through to a positive direct voltage terminal (denoted by reference character B+ here), whereas a negative half-wave present at a corresponding phase connection is switched through to a negative direct voltage terminal (B−). For this purpose, the particular MOSFETs or active switching elements in the rectifier bridges of such a bridge rectifier are suitably connected, as also explained with reference to FIG. 1.

In contrast, in the short circuit operating mode, the phase connections are short-circuited by controlling the active switching elements, so that no output voltage is output by the bridge rectifier at the direct voltage terminals of the bridge rectifier. If a vehicle electrical system in question in a short circuit operating mode is not supplied with power in some other way, the voltage which is detectable at the direct voltage terminals, and thus the voltage in the vehicle electrical system, drops.

In the event of detected load shedding, for example when a signal which characterizes a voltage that drops between the direct voltage terminals of the bridge rectifier exceeds an upper threshold value, a short circuit operating mode is initiated. The short circuit operating mode is maintained as long as the signal does not subsequently fall below a lower threshold value. As explained, it is conventional to discontinue the short circuit operating mode as soon as the described signal in a short circuit operating mode falls below a lower threshold value.

The signal which characterizes the voltage present between the direct voltage terminals of the bridge rectifier does not have to represent a raw signal, for example an appropriately measured voltage: to avoid, for example, detection of an error for voltage peaks which occur only briefly, an appropriate signal may in particular also be filtered. This is necessary primarily for signal shapes as depicted in FIG. 3 and diagram 31 therein. When such a phase short circuit is deactivated, this results in a temporary voltage peak (see point in time T0) which exceeds a corresponding detection threshold VH. If an unfiltered signal were used, at this point in time a short circuit which had just been initiated would already be deactivated.

A control signal having a defined switching time is preferably used for controlling the active switching elements. A switching time used in a first method phase within the scope of the present invention is referred to here as the “first switching time.”

It is conventional that for control with a signal having flat signal edges (i.e., with a fairly long switching time), active switching elements change from the blocking state into the conductive state only comparatively slowly. Voltage peaks during the connection of inductive loads on a rectifier may be avoided in this way.

As is generally conventional, the forward resistance between the drain and the source in transistors, such as the mentioned MOSFET, depends on the voltage present between the gate and the source. Below a so-called threshold voltage, the connection between the drain and the source via the transistor is high-impedance, and below this threshold voltage, is low-impedance. The forward resistance drops when the threshold voltage is reached, but does not drop suddenly to its minimum value, in which it is “shot through,” as referred to in common usage. Rather, when the voltage between the gate and the source increases beyond the threshold voltage, the resistance initially drops greatly, but only to a certain value above its minimum value. The minimum forward resistance does not occur until the voltage at the gate is further increased, for example by 1 to 2 V. Thus, when a control signal is slowly passed through this area, a correspondingly “slow” switching of the transistor is achieved.

This “slow” switching is advantageous in particular during initiation and in particular deactivation of the described short circuits during load shedding, in which the vehicle electrical system is still connected to the rectifier (i.e., not during load shedding due to a cable break). The lines of the vehicle electrical system represent inductive loads, so that voltage peaks may occur. In such cases, it is therefore recommended to use longer switching times to reduce the voltage peaks. However, since the transistors involved are under comparatively heavy load, and since increased power losses result for “slow” switching during routine rectifier operation, a corresponding longer switching time is advantageously used only when it is actually necessary.

According to the present invention, it is provided that, after the bridge rectifier has been operated at least once in the short circuit operating mode in the first method phase, a determination is made, based on at least one feature of the signal which characterizes the voltage present between the direct voltage terminals of the bridge rectifier, whether the signal has exceeded the upper threshold value due to a cable break at at least one of the direct voltage terminals. If this is the case, in a second method phase the bridge rectifier is subsequently operated in the short circuit operating mode for an extended period of time, and/or in the second method phase a control signal having a second, shorter switching time is used for controlling the active switching elements. The latter is advantageous in particular due to the fact that when a cable break is detected, there is no need for connecting inductive loads, and therefore a shorter switching time (with less load on the transistors employed) may be used. Since the components of a vehicle electrical system (separate from the rectifier) also do not have to be taken into account in such a case, an extended time period may also be used for the short circuit operating mode. The transistors are likewise protected in this way.

As explained below, a duration of the at least one short circuit operating mode may be used as a criterion for whether the signal has exceeded the upper threshold value due to a cable break. This is also illustrated in the discussion below with reference to FIGS. 3 and 4. Similarly, an exceedance of a detection threshold value after the start of the at least one short circuit operating mode may also be used. As likewise explained below, a voltage dip occurs after the start of the short circuit operating mode when consumers are disconnected, but not in the event of a cable break, which likewise may be used as a criterion for differentiation.

The “lengthening” of the time period in which the bridge rectifier is operated in the short circuit operating mode in the second method phase may take place, for example, by specifying an appropriate short circuit operating mode time, in particular of 0 to 1.5 seconds, for example 0.5 to 1 seconds. Overvoltages or corresponding generator power are/is reduced during such a time period. Lengthening of a short circuit operating mode may also take place by reducing the lower threshold value, i.e., by discontinuing the short circuit operating mode in a delayed manner.

The first and second switching times which are usable within the scope of the present invention are in particular in a range of 10 μs to 200 μs (first switching time) and in a range of 0 μs to 20 μs (second switching time).

In selecting the first switching time, in particular generator current I_generator at the time of the switching operation and vehicle electrical system inductance L_vehicle electrical system between the rectifier and a capacitor in the vehicle electrical system (see capacitor C1 according to FIG. 2) should be taken into account. Induced voltage U_induced satisfies the equation

U_induced=L_vehicle electrical system×dI_generator/dt

The higher the vehicle electrical system inductance and the lower the allowable induced voltage, the slower the switching operation that must be selected.

In addition, an adjustment of filtering times used for providing the signal, which characterizes the voltage present between the direct voltage terminals of the bridge rectifier, may take place. The time during which the switching elements are subjected to load (see time period T1-T0 according to FIG. 4) may be reduced by decreasing the filtering times.

A processing unit according to the present invention, such as a control device of an active bridge rectifier of a motor vehicle electrical system, is configured, in particular by programming, for carrying out the method.

In addition, the implementation of the method in the form of software is advantageous, since this entails particularly low costs, in particular when an executing control unit may also be used for other tasks, and therefore is present anyway. Suitable data carriers for providing the computer program are in particular diskettes, hard drives, flash memories, EEPROMs, CD-ROMs, DVDs, and others. In addition, downloading a program via computer networks (Internet, intranet, etc.) is possible.

Further advantages and embodiments of the present invention are described below and shown in the figures.

It is understood that the features mentioned above and explained below may be used not only in the particular stated combination, but also in other combinations or alone without departing from the scope of the present invention.

The present invention is schematically illustrated in the figures based on exemplary embodiments, and described in greater detail below with reference to the figures.

### BRIEF DESCRIPTION OF THE DRAWINGS

FIG. 1 shows a vehicle electrical system which includes a bridge rectifier, a generator, and a control device, in a schematic partial illustration.

FIG. 2 shows a system for simulating load shedding in a vehicle electrical system, in a schematic illustration.

FIG. 3 shows current and voltage patterns during load shedding due to disconnection of consumers, in the form of diagrams.

FIG. 4 shows current and voltage patterns during load shedding due to a cable break, in the form of diagrams.

In the figures, mutually corresponding elements have identical reference numerals, and for the sake of clarity, explanations of same are not repeated.

### DETAILED DESCRIPTION OF EXAMPLE EMBODIMENTS

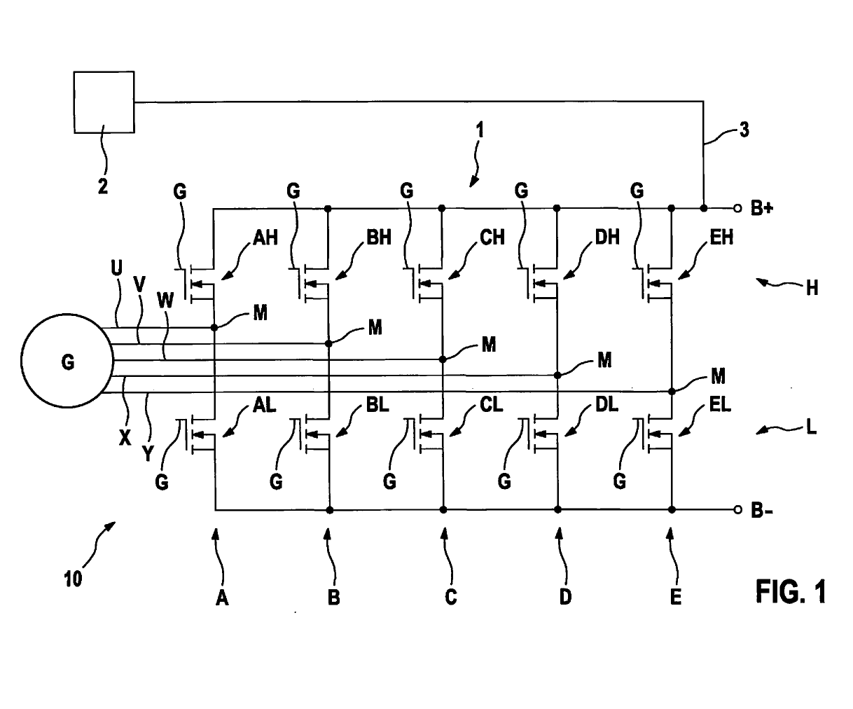

FIG. 1 schematically illustrates a conventional system which includes a bridge rectifier 1 and a generator G, using the example of a five-phase system. Bridge rectifier 1 is illustrated in FIG. 1 as a ten-pulse bridge rectifier which is configured for rectifying a three-phase current of a five-phase generator G. However, a three-, four-, six-, or seven-phase generator G and a correspondingly adapted six-, eight-, twelve-, or fourteen-pulse bridge rectifier 1, for example, may similarly also be used. Bridge rectifier 1 is part of a vehicle electrical system 10, which is only partially illustrated here.

Bridge rectifier 1 has five half bridges A through E, which are respectively connected via their center tap M to the five generator phases or corresponding phase connections U through Y.

Half bridges A through E are each connected at their ends to direct voltage terminals B+ and B−, for example battery terminals and/or corresponding supply lines of a vehicle electrical system 10. Terminal B− may be connected to ground.

Half bridges A through E each include active switching elements AH through EH and AL through EL, which are depicted here as

MOSFETs. These are respectively integrated into an upper branch H (high-side) and a lower branch L (low-side) of individual half bridges A through E.

Phase connections U through Y may each be connected to one of the two direct voltage terminals B+ or B− according to an appropriate wiring of active switching elements AH through EH and AL through EL. When two or more phase connections U through Y are in each case connected to the same direct voltage terminal B+ or B−, this is equivalent to a short circuit of these phase connections U through Y via respective direct voltage terminal B+ or B−.

Active switching elements AH through EH and AL through EL are wired via their respective gate terminals G by a control device 2 via control lines, not illustrated. A single control device 2 may be provided for all half bridges A through E. Alternatively, each half bridge A through E may also have its own control device. In the latter case, functions may be arbitrarily distributed between individual control devices and a shared control device 2.

The normal operation of bridge rectifier 1 includes controlling active switching elements AH through EH and AL through EL in such a way that current signals present at phase connections U through Y are “shot through” to B+ and B− in alternation, depending on the current direction.

In a system illustrated in FIG. 1, load shedding may be detected based, for example, on a voltage that is present at direct voltage terminal B+. For this purpose, control device 2 is connected to direct voltage terminal B+ via a line 3. Load shedding is present when a defined voltage threshold value is exceeded.

When load shedding is detected, the control of rectifier 1 may include temporarily short-circuiting phase connections U through Y in a defined manner. As a result, the current fed to the vehicle electrical system drops to zero, and the voltage detected across line 3 drops. Such a short circuit may be created by simultaneously controlling, and thus conductively connecting, some or all switching elements AH through EH on the one hand or AL through EL on the other hand, i.e., some or all switching elements of a rectifier branch H or L, respectively. When such a short circuit is deactivated, the current fed to the vehicle electrical system and the voltage detected across line 3 rise once again.

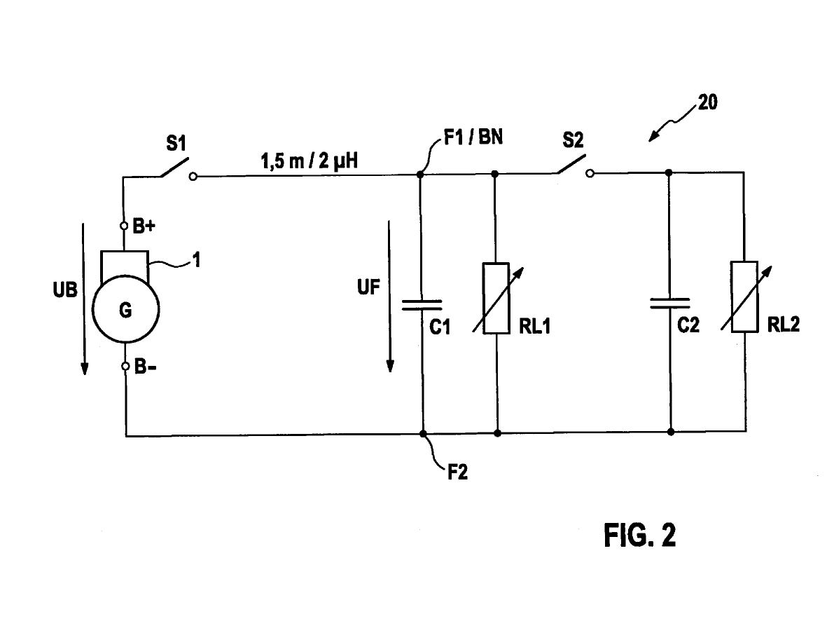

FIG. 2 illustrates a circuit, denoted overall by reference numeral 20, for simulating load sheddings in a vehicle electrical system of a motor vehicle. At the same time, circuit 20 represents an equivalent circuit diagram of a vehicle electrical system 10 into which a generator G and a rectifier 1, for example as illustrated in FIG. 1 described above, are integrated. As described, such a vehicle electrical system may also include generators G and/or rectifiers 1 having a different number of phases or pulses.

A voltage UB is present at generator G together with rectifier 1, as depicted by an appropriately inscribed arrow. Capacitors C1 and C2 and load resistors RL1 and RL2 represent capacitors and resistors, respectively, of an actual vehicle electrical system. Capacitor C1 corresponds to a capacitor at a jump start assistance point, which is provided for jump starting the motor vehicle in question. Terminals F1 and F2 are provided for starting assistance. At a point BN, which may correspond to terminal F1, a vehicle electrical system voltage may be measured, for example against ground or terminal F2. Capacitor C1 is provided, among other things, for buffering voltage fluctuations in the vehicle electrical system. The voltage dropping across capacitor C1 is likewise depicted by an arrow, and is denoted by reference character UF.

It is pointed out that in customary motor vehicles, generator G together with rectifier 1 on the one hand and capacitor C1 on the other hand, or also point BN or terminals F1 and F2, are separated from one another by lines having a length of typically 1.5 to 2 meters and a cross section of 25 square millimeters, for example. In contrast, in the following discussion the direct voltage terminals of the rectifier, B+ and B−, are regarded as terminals which are provided directly at the rectifier. For example, terminals F1 and F2 and point BN, as explained, are separated therefrom by corresponding line lengths.

The described lines having the stated properties essentially correspond to inductances in the electrical equivalent circuit diagram. These inductances are responsible for voltage peaks resulting during rapid current changes at direct voltage terminals B+ and B− of rectifier 1. The voltages at the jump start assistance point, i.e., voltage UF, which drops against ground between terminals F1 and F2 or point BN, therefore cannot be detected directly by an electronics system mounted on generator G or rectifier 1. The present invention also takes this into account.

When reference is made below to “voltages at the rectifier,” this involves voltages which may be measured directly at rectifier 1, i.e., at terminal B+, for example. These voltages are also denoted by reference character VB+. Due to the described inductances of the lines, the time curves of these voltages may possibly differ from the corresponding time curves of “voltages at the vehicle electrical system,” which may be measured at terminal F1 or point BN, for example. A cable length between switch S1 (see below) and point BN or terminal F1 may be 1.5 m, for example, and the inductance of a corresponding cable is 2 μH, for example, as shown in FIG. 2.

Switches S1 and S2 are provided for simulation of load sheddings. At the start of a load shedding test or a corresponding simulation, both switches S1 and S2 are closed. Generator G or rectifier 1 delivers a current, which results from load resistors RL1 and RL2, to the vehicle electrical system. Load shedding may be simulated by opening one of switches S1 or S2. Opening of switch S1 thus corresponds to a load drop to 0%, which in reality would be caused, for example, by the drop on the connecting cable at the generator (cable break). In contrast, opening switch S2 simulates a partial load drop which is caused by switching off a fairly large resistive load, RL2 in the present case, in the vehicle electrical system. The value of the “shed” load current may be adjusted via the resistance value of load resistor RL2, and the value of the residual vehicle electrical system current may be adjusted via the resistance of load resistor RL1.

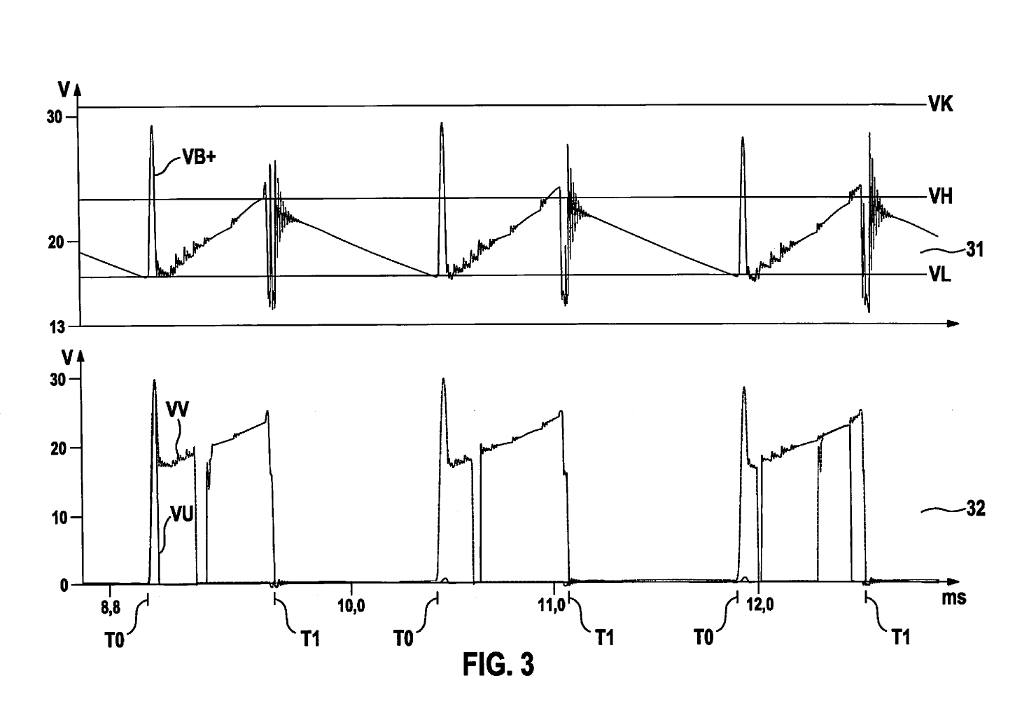

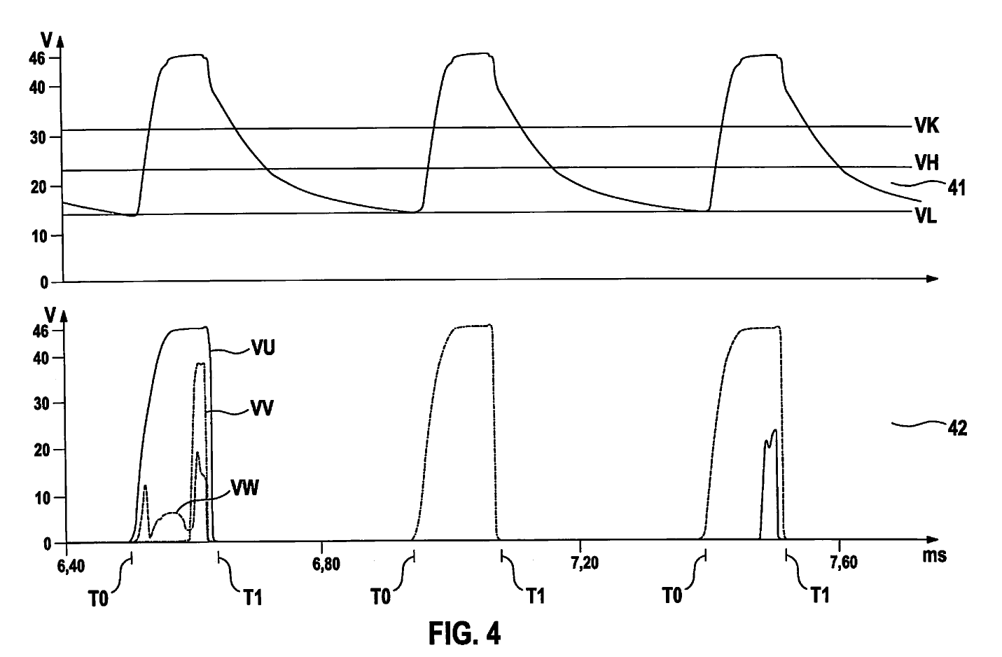

FIGS. 3 and 4 each illustrate diagrams with voltage patterns at positive direct voltage terminal B+(diagrams 31 and 41, respectively) and at selected phase connections (diagrams 32 and 42, respectively), plotted in V on the ordinate as a function of time in ms on the abscissa.

FIG. 3 shows voltage patterns which typically result from load shedding caused by disconnection of consumers in a vehicle electrical system. Voltage signal VB+ illustrated in diagram 31 may be obtained by measuring a bridge rectifier between B+ and B− (see FIG. 1). Such a voltage signal VB+, as illustrated in diagram 31, results in particular during battery-free operation and when a high-load consumer is disconnected.

In the diagrams illustrated in FIG. 3, a phase short circuit as described above is deactivated in each case at point in time T0. At point in time T0, in each case this results in a distinct voltage peak due to the line inductances in the vehicle electrical system, mentioned numerous times herein. After the vehicle electrical system inductance has completely accepted the generator current, the voltage at B+ once again assumes the value of vehicle electrical system voltage BN. The voltage value after the voltage peak essentially corresponds to the voltage value prior to the voltage peak. This voltage value is specified by the characteristic of a hysteresis element used, whose lower threshold value is denoted by reference character VL in diagram 31. Voltage VB+ subsequently continuously rises. Just before point in time T1, voltage VB+ in each case reaches an upper threshold value VH, which is approximately 23.5 V in this case.

A phase short circuit, as described above, is initiated at a point in time T1 based on an appropriate threshold value detection. This initially results in a marked voltage dip in voltage signal VB+, which is specific as a detection feature for load sheddings which result from disconnection of consumers in the vehicle electrical system (but not from a cable break at the generator).

Due to the short-circuiting of the phase connections between points in time T1 and T0 (i.e., in a short circuit operating mode), voltage VB+ drops, and just before point in time T0, reaches a lower threshold value VL, approximately 17 V in this case, which, as described, is settable in the control unit via the lower threshold value of the hysteresis element.

An additional threshold value, denoted here by reference character VK, may likewise be used for differentiating load sheddings that result from the disconnection of consumers on the one hand, and from cable breaks on the other hand. In diagram 31, threshold value VK, i.e., in the event of disconnection of consumers, is never reached by signal VB+, so that on this basis it may be established that no cable break is present.

For the purpose of illustration, two of the five phase voltages which are present at phase connections U through Y of a corresponding electric machine or a generator G (see FIG. 1) are depicted in diagram 32. These are the voltages at phase connections U and V, denoted here by reference characters VU and VV. The voltages drop to 0 V due to the phase short circuit between points in time T1 and T0.

As previously explained, the illustration in diagrams 41 and 42 of FIG. 4 essentially corresponds to the illustration in diagrams 31 and 32 of FIG. 3. However, FIG. 4 depicts load sheddings which result from a cable break. In addition, three voltage signals, denoted here by reference characters VU, VV, and VW, at the phase connections of an electric machine G are illustrated in diagram 42.

As is apparent from a comparison of FIGS. 3 and 4, the time interval T0 between the deactivation of the short circuit and the renewed initiation of a corresponding short circuit T1 in the event of a cable break (FIG. 4) is much shorter than for the disconnection of a consumer in the vehicle electrical system. According to FIG. 4, this time interval is approximately 15 ms, and according to FIG. 3 is approximately 60 ms. This difference may be used as a feature for differentiating the stated causes for load shedding.

In addition, it is apparent in particular from a comparison of diagrams 41 and 31 that hardly any voltage dips occur when a phase short circuit is activated at points in time T1 during load shedding due to a cable break (FIG. 4). This is attributed to the fact that in the event of a cable break, current in an inductance of a vehicle electrical system does not have to be recommutated.

Another criterion which allows a differentiation between the stated causes for load shedding is the exceedance of threshold value VK, already explained with reference to FIG. 3. Since much higher voltages result in the event of a cable break (up to 46 V here), threshold value VK is exceeded, so that such an exceedance may be used as a further criterion for load shedding caused by a cable break.

As is apparent from diagram 32, voltage VB+ temporarily rises considerably above the actual switching threshold when a phase short circuit is deactivated. The voltage subsequently drops very quickly back to the original voltage (approximately 17 V, as previously stated). Only then does voltage VB+ once again rise gradually (i.e., within a time period of approximately 0.6 ms) due to the charging of the vehicle electrical system capacitance, until activation threshold VH for the phase short circuit is once again exceeded.

In contrast, it is apparent in diagram 41 that in the event of a cable break, the voltage rises to a very high value (as mentioned, almost 46 V), but then (initially) remains there. This is due to the arresting effect of the avalanche breakdown of the transistors involved. If additional elements for arresting are provided in a corresponding rectifier, as is likewise possible in principle, this voltage may also be below the avalanche voltage of the transistors used.

If the voltage peak in diagram 31 reaches value VK due to a higher vehicle electrical system inductance or a faster switching speed, the differentiation may be expanded by evaluating the time at which signal VB+ exceeds threshold value VK.

The duration of the voltage peak or a corresponding voltage plateau in signal VB+ may therefore be utilized as a criterion for whether an inductive current is connected, or a cable break is present. If such a voltage peak has a longer duration than is plausible based on the vehicle electrical system inductance and the connected current, it may be assumed that a cable break is present.

1-11. (canceled)

12. A method for operating a motor vehicle electrical system which includes an electric machine which is operable in a generator mode, and an active bridge rectifier which is connected to the electric machine via phase connections and which is operable in a rectifier operating mode and a short circuit operating mode, the method comprising:
in the rectifier operating mode, converting phase voltages present at the phase connections into an output voltage, outputting the output voltage at direct voltage terminals of the bridge rectifier by controlling active switching elements of the bridge rectifier;
in the short circuit operating mode, short-circuiting the phase connections by controlling the active switching elements so that no output voltage is output by the bridge rectifier at the direct voltage terminals of the bridge rectifier, the short circuit operating mode being initiated as soon as a signal which characterizes a voltage that drops between the direct voltage terminals of the bridge rectifier exceeds an upper threshold value;
in a first method phase, discontinuing the short circuit operating mode as soon as the signal subsequently falls below a lower threshold value, and using a control signal having a first switching time for controlling the active switching elements;
after the bridge rectifier has been operated at least once in the short circuit operating mode in the first method phase, determining, based on at least one feature of the signal, whether the signal has exceeded the upper threshold value due to a cable break at at least one of the direct voltage terminals, and if so:
at least one of: i) in a second method phase, the bridge rectifier is subsequently operated in the short circuit operating mode for an extended period of time, and ii) in the second method phase, a control signal having a second, shorter switching time is used for controlling the active switching elements, in which a duration of the at least one short circuit operating mode in which the bridge rectifier has been operated in the first method phase is used as the at least one feature of the signal.

13. The method as recited in claim 12, wherein a lack of a voltage dip after a start of the at least one short circuit operating mode in which the bridge rectifier has been operated in the first method phase is used as the at least one feature of the signal.

14. The method as recited in claim 12, wherein an exceedance of a detection threshold value after a start of the at least one short circuit operating mode in which the bridge rectifier has been operated in the first method phase is used as the at least one feature of the signal.

15. The method as recited in claim 12, wherein in the second method phase, the bridge rectifier is operated in the short circuit operating mode for 0 s to 1.5 s.

16. The method as recited in claim 15, wherein in the second method phase, the bridge rectifier is operated in the short circuit operating mode for 0.5 s to 1 s.

17. The method as recited in claim 12, wherein in the second method phase, the bridge rectifier is operated in the short circuit operating mode for an extended period of time in such a way that the lower threshold value is reduced.

18. The method as recited in claim 12, wherein in the second method phase, a control signal having a second, shorter switching time is used for controlling the active switching elements, the first switching time being in a range of 10 μs to 200 μs and the second switching time being in a range of 0 μs to 20 μs.

19. The method as recited in claim 12, wherein the signal os filtered, a first filtering time being used in the first method phase and a second filtering time being used in the second method phase.

20. A motor vehicle electrical system which includes an electric machine which is operable in a generator mode, and an active bridge rectifier which is connected to the electric machine via phase connections and which is operable in a rectifier operating mode and a short circuit operating mode, and which includes a control device which is configured to
in the rectifier operating mode, convert phase voltages present at the phase connections into an output voltage, the output voltage being output at direct voltage terminals of the bridge rectifier by controlling active switching elements of the bridge rectifier;
in the short circuit operating mode, short-circuit the phase connections by controlling the active switching elements so that no output voltage is output by the bridge rectifier at the direct voltage terminals of the bridge rectifier;
initiate the short circuit operating mode as soon as a signal which characterizes a voltage that drops between the direct voltage terminals of the bridge rectifier exceeds an upper threshold value;
in a first method phase, discontinue the short circuit operating mode as soon as the signal subsequently falls below a lower threshold value, and use a control signal having a first switching time for controlling the active switching elements; and
after the bridge rectifier has been operated at least once in the short circuit operating mode in the first method phase, determine, based on at least one feature of the signal, whether the signal has exceeded the upper threshold value due to a cable break at at least one of the direct voltage terminals, and if so:
at least one of: i) in a second method phase, subsequently operate the bridge rectifier in the short circuit operating mode for an extended period of time, and ii) in the second method phase, use a control signal having a second, shorter switching time for controlling the active switching elements, in which a duration of the at least one short circuit operating mode in which the bridge rectifier has been operated in the first method phase is used as the at least one feature of the signal.

21. A control device for a motor vehicle electrical system, the motor vehicle electrical system including an electric machine which is operable in a generator mode, and an active bridge rectifier which is connected to the electric machine via phase connections and which is operable in a rectifier operating mode and a short circuit operating mode, the control device configured to:
in the rectifier operating mode, convert phase voltages present at the phase connections into an output voltage, the output voltage being output at direct voltage terminals of the bridge rectifier by controlling active switching elements of the bridge rectifier;
in the short circuit operating mode, short-circuit the phase connections by controlling the active switching elements so that no output voltage is output by the bridge rectifier at the direct voltage terminals of the bridge rectifier;
initiate the short circuit operating mode as soon as a signal which characterizes a voltage that drops between the direct voltage terminals of the bridge rectifier exceeds an upper threshold value;
in a first method phase, discontinue the short circuit operating mode as soon as the signal subsequently falls below a lower threshold value, and use a control signal having a first switching time for controlling the active switching elements; and
after the bridge rectifier has been operated at least once in the short circuit operating mode in the first method phase, determine, based on at least one feature of the signal, whether the signal has exceeded the upper threshold value due to a cable break at at least one of the direct voltage terminals, and if so:
at least one of: i) in a second method phase, subsequently operate the bridge rectifier in the short circuit operating mode for an extended period of time, and ii) in the second method phase, use a control signal having a second, shorter switching time for controlling the active switching elements, in which a duration of the at least one short circuit operating mode in which the bridge rectifier has been operated in the first method phase is used as the at least one feature of the signal.

22. A computer-readable storing a computer program for operating a motor vehicle electrical system which includes an electric machine which is operable in a generator mode, and an active bridge rectifier which is connected to the electric machine via phase connections and which is operable in a rectifier operating mode and a short circuit operating mode, the computer program, when executed by a controller, causing the controller to perform:
in the rectifier operating mode, converting phase voltages present at the phase connections into an output voltage, outputting the output voltage at direct voltage terminals of the bridge rectifier by controlling active switching elements of the bridge rectifier;
in the short circuit operating mode, short-circuiting the phase connections by controlling the active switching elements so that no output voltage is output by the bridge rectifier at the direct voltage terminals of the bridge rectifier, the short circuit operating mode being initiated as soon as a signal which characterizes a voltage that drops between the direct voltage terminals of the bridge rectifier exceeds an upper threshold value;
in a first method phase, discontinuing the short circuit operating mode as soon as the signal subsequently falls below a lower threshold value, and using a control signal having a first switching time for controlling the active switching elements;
after the bridge rectifier has been operated at least once in the short circuit operating mode in the first method phase, determining, based on at least one feature of the signal, whether the signal has exceeded the upper threshold value due to a cable break at at least one of the direct voltage terminals, and if so:
at least one of: i) in a second method phase, the bridge rectifier is subsequently operated in the short circuit operating mode for an extended period of time, and ii) in the second method phase, a control signal having a second, shorter switching time is used for controlling the active switching elements, in which a duration of the at least one short circuit operating mode in which the bridge rectifier has been operated in the first method phase is used as the at least one feature of the signal.
